(19) United States
(12) Patent Application Publication
(10) Pub. No.: US 2004/0234646 A1
(43) Pub. Date: Nov. 25, 2004

(54) Tip jacket for plastic injection molding nozzles

(76) Inventor: Salvatore Benenati, Ocean, NJ (US)

Correspondence Address: STRAUB & POKOTYLO, 620 TINTON AVENUE, BLDG. B, 2ND FLOOR, TINTON FALLS, NJ, 07724, US

(21) Appl. No.: 10/440,057

(22) Filed: May 16, 2003

(51) Int. Cl. B29C 45/20

(52) U.S. Cl. 425/567

(57) ABSTRACT

Am improved tip jacket for plastic injection molding nozzeles is described.

### BACKGROUND OF THE INVENTION

Injection molding of thermoplastic resin is commonly done by injecting molten plastic from an injection molding press barrel into a metal mold which has a suitable number of impressions or “cavities” in the shape of the parts to be produced.

In cases where the mold has multiple cavities, the molten resin is routed to the individual cavities through channels, which are commonly called “runners”.

Once solidified, the material in these channels is ejected together with the parts when the mold opens, and is first separated from the product, then discarded or reground for re-use.

In order to maintain the integrity of the product, only a small percentage of reground material can be added to virgin resin, therefore runners are by enlarge an expensive waist by-product.

To alleviate this situation, “Hot Runner” technology has bee developed for the most part during the last two decades.

By this method, some of the mold components, mainly a manifold-nozzles assembly, are kept hot by electric resistance heaters; the plastic is channeled through these heated components, and fed to the cavities via a small port called “gate”. A heated, pointed “torpedo” protrudes through the nozzle and keeps the plastic in the gate from solidifying and blocking the passage.

Normally, a small pool of plastic surrounds the torpedo to insulate it thermally from the metal of the mold. This insulating pool presents problems when heat sensitive plastics are molded or when color changes are required.

While the material closest to the torpedo remains molten at all times during the operation, evacuating at each cycle; the material closest to the mold's metal solidifies forming a stationary layer. A third, semi-molten layer forms between the molten and solid layers. Being exposed to high temperatures for extended time periods, this layer often becomes degraded. During injection cycles, portions of this layer randomly finds it's way into the product, creating quality problems.

If resin of different color is introduced, the semi-molten layer, which contains the old color, leeches into the parts at random, requiring long change over times to clear the contamination and therefore substantial waste of materials and energy.

Attempting to solve this problem, various designs have employed insulators manufactured of a plastic material that melts at very high temperatures and that reduce the flow area around the torpedo tips. These insulators have met with limited success, because over time, the material ages, becomes brittle and breaks off into small pieces to be carried by the flowing melt and clog the gates, causing loss of production and expensive repairs.

Another attempt has been to design smaller insulating pools. In order to reduce heat losses due to the decrease in insulation thickness, the nozzles and tips have to be modified to have very thin sections in the areas of contact with the mold, making the units very delicate and difficult to maintain and service.

### SUMMARY OF THE INVENTION

The present invention relates particularly to the nozzles used in hot runner systems. It's objective is to eliminate leeching of degraded or residual resins into the injection molded parts. To create a physical barrier between the molten layer and the rest of the gate's insulating pool, and to retain the advantages of having a thick insulation, formed by the same plastic that is being used to produce the parts. Further advantages are a structurally stronger and more durable nozzle construction and the adaptability of the design to retrofit existing systems.

### BRIEF DESCRIPTION OF DRAWINGS

FIG. 1 is a section view of an elevation of an injection mold incorporating a hot runner system with nozzles using tip jackets in accordance to the invention

FIG. 2 is a rear view of the mold in FIG. 1

FIG. 3 is an elevation of a hot runner nozzle with coil heater and tip jacket mounted in place.

FIG. 4 is a front view of the nozzle in FIG. 3

FIG. 5 is a cross section along the vertical axis of the nozzle in FIG. 3

FIG. 6 is a cross section of a nozzle/manifold segment along their vertical axis, fitted in a cavity block of the mold.

FIG. 7 is a cross section of a hot runner nozzle employing integral heating elements with a tip jacket mounted in place.

FIG. 8 is an external view of the tip section of the nozzle in FIG. 7.

FIG. 9 is a cross sectional view of the nozzle in FIG. 7 fitted in a cavity block of an injection mold.

FIG. 10 is an elevation of the tip jacket of the nozzle shown in FIG. 3.

FIG. 11 is a cross section along the vertical axis of tip jacket shown in FIG. 10

FIG. 12 is a front view of tip jacket shown in FIG. 10.

FIG. 13 is an elevation of the tip jacket of the nozzle shown in FIG. 7.

FIG. 14 is a cross section along the vertical axis of tip jacket shown in FIG. 13

FIG. 15 is a front view of the tip jacket shown in FIG. 13.

### DETAILED DESCRIPTION OF PREFERRED EMBODYMENT

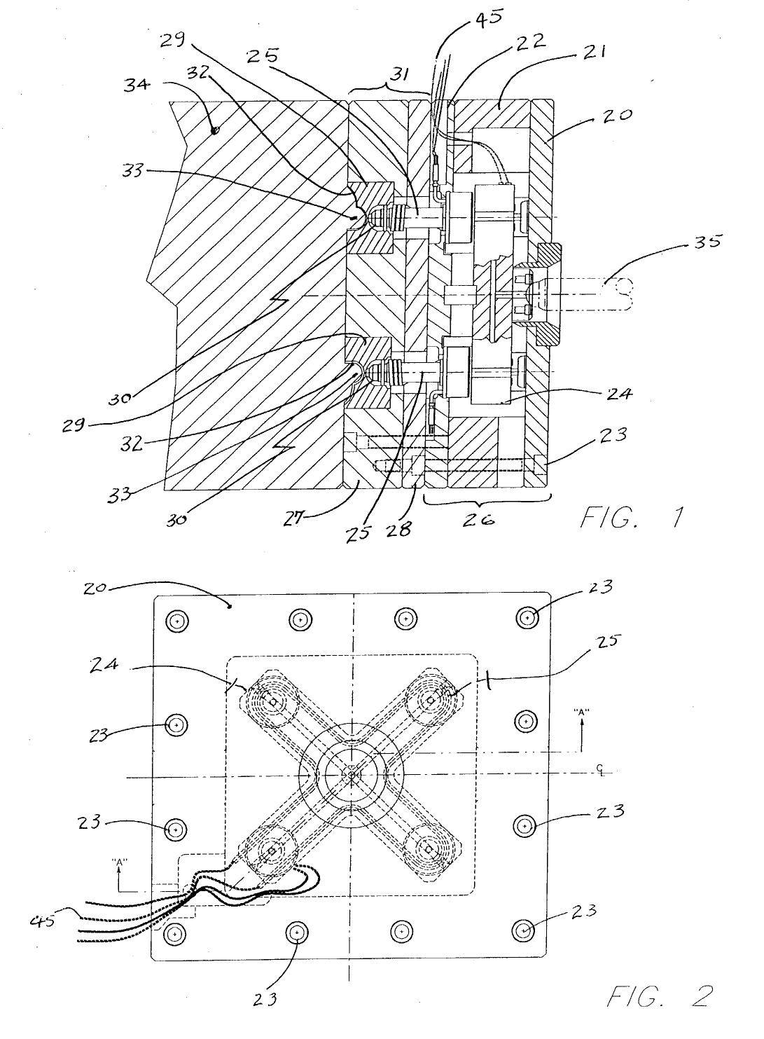

FIG. 1 is a section along line A-A of FIG. 2. The plastic injection mold assembly represented is along the general lines of construction in use by the industry today. Steel plates 20 and 22 are fastened with screws 23 in such way as to clamp plate 21, manifold 24 and nozzle 25; keeping them under pressure and combining them into sub-assembly 26 which is commonly called the “Hot Half” of the mold. Tip jackets 30 are mounted at the front end of nozzles 25. Plates 27 and 28 contain the actual cavity blocks 29 of the parts to be formed 32, and combine into a sub-assembly 31 called the “Cavity Side” of the mold. The male part 33 of the cavities are called “Cores” and are mounted to an assembly 34 normally called the “Core Side” of the mold, shown in diagram form only. In use, molten plastic resin is injected from injection molding press nozzle 35 into the manifold 24 which distributes it to nozzles 25 that further convey it to the cavities to form parts 32. The Core Side 34 is then separated and the parts ejected.

Manifold 24 is “X” shaped as represented in FIG. 2. Wires 45 connect the manifold and the nozzles to a suitable power source.

FIG. 3 shows nozzle 25 removed from the mold and fitted with a coil heater 42 of suitable wattage to provide sufficient heat to elevate the nozzle's temperature to the required operating level. Wires 45A are connected to a suitable power source to energize coil heater 42. Collar 43 is a removable piece that is assembled to the nozzle by means of an internal thread, and is provided with wrench flats 46 for tightening it securely to the nozzle.

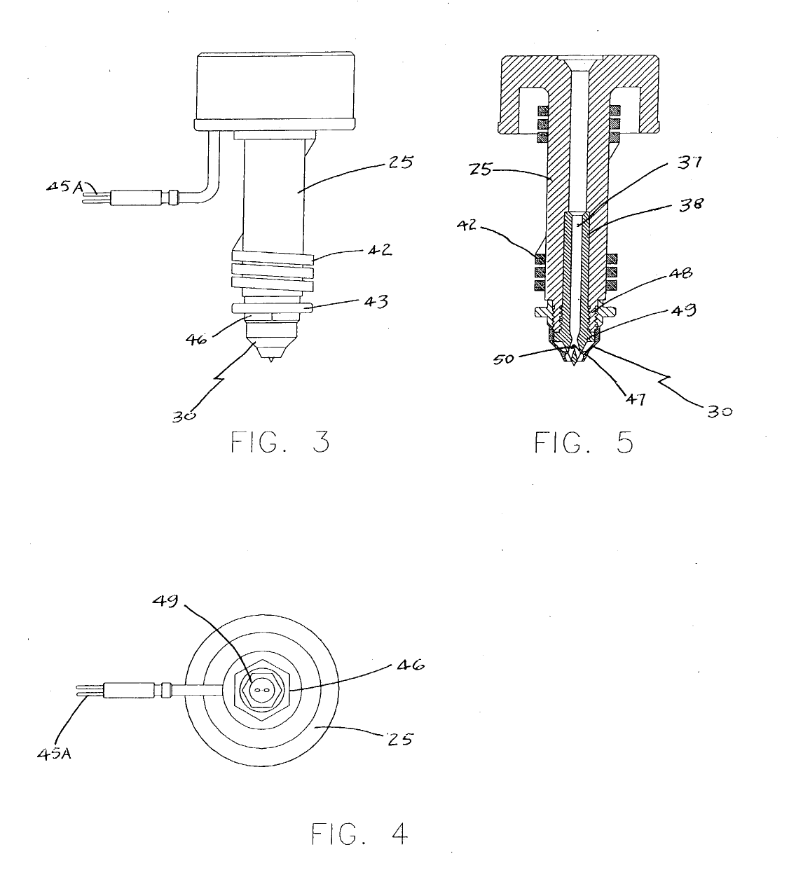

Referring to FIG. 5, torpedo 38 is fastened to the nozzle body by threads 48, and is provided with a hexagonal shaped head 49 for allowing tightening it to the body of nozzle 25 by means of a wrench. Torpedo 38 is made of a highly heat conductive beryllium-copper alloy and is provided with a melt passage 37 which communicates with two orifices 50 located near the tip, for the purpose of allowing the molten plastic a through path to the gate. Tip jacket 30, in the embodiment shown in the drawings, is assembled to nozzle 25 by means of a short thread. However, it can be attached to the nozzle by several methods obvious to those skilled in the art, including a separate retaining nut or by press fit. The tip jacket 30 is made of a metal that has properties of high strength and poor heat conductivity, such as stainless steel alloy, a titanium alloy or a ceramic material. In order to reduce the heat losses to a minimum, the jacket walls' thickness is very thin, on the order of 0.020 inches. An internal, thin walled fin 47 comes in contact with the tip of torpedo 38 just above orifices 50 through which the molten resin exits the torpedo. Fin 47 works as a flow deflector, directing all the plastic coming out of the orifices towards the gate.

Referring to FIG. 6, when plastic is first injected from the injection molding press, it goes through melt channel 35 of manifold 24, through melt channel 36 of nozzle 25, through melt channel 37 of torpedo 38, through orifices 50 of torpedo's tip and through gate 39 into the cavity 32. As soon as the cavity is filled, due to back-pressure, the plastic material goes through a small gap 40 located between tip jacket 30 with cavity block 29. This gap can be only approximately 0.005 inches, which is sufficiently wide to allow plastic material to fill the insulation pool 41. In this design, the pool is very important for thermally insulating the tip and maintaining the tip's temperature to a level adequate to keep the material in the gate molten. If the tip were positioned too close to the cavity block, due to lack of insulation, heat would be drawn in sufficient amounts to lower it's temperature and cause the resin in the gate to solidify, preventing the flow of plastic to the cavity.

Nozzle 25 is heated by coil-heater 42, which is coiled around the body of the nozzle unevenly to better heat up the areas where most of the heat losses occur. Threaded collar 43 keeps the cylindrical nozzle 25 centered to pool 41 and to gate 39. Thread 44, besides retaining the collar 43 assembled to the nozzle, works as an insulator by reducing the contact area of the nozzle with the collar, therefore reducing the migration of heat to the cavity block. This heat loss could be substantial due to the fact that in most cases the block is cooled by means of water channels not shown here for clarity purposes.

Prior to injecting any molten plastic in the system, pool 41 is empty, therefore jacket 30 initially has no external support along its walls. Once plastic fills the pool and surrounds the tip and the outside of the jacket, it provides support from the outside so that the stress subjecting the jacket during operation is minimized. The walls of the jacket prevent the high velocity high pressure melt flow from getting intermingled with the plastic in the pool, ensuring that the molded parts are formed with 100% fresh resin.

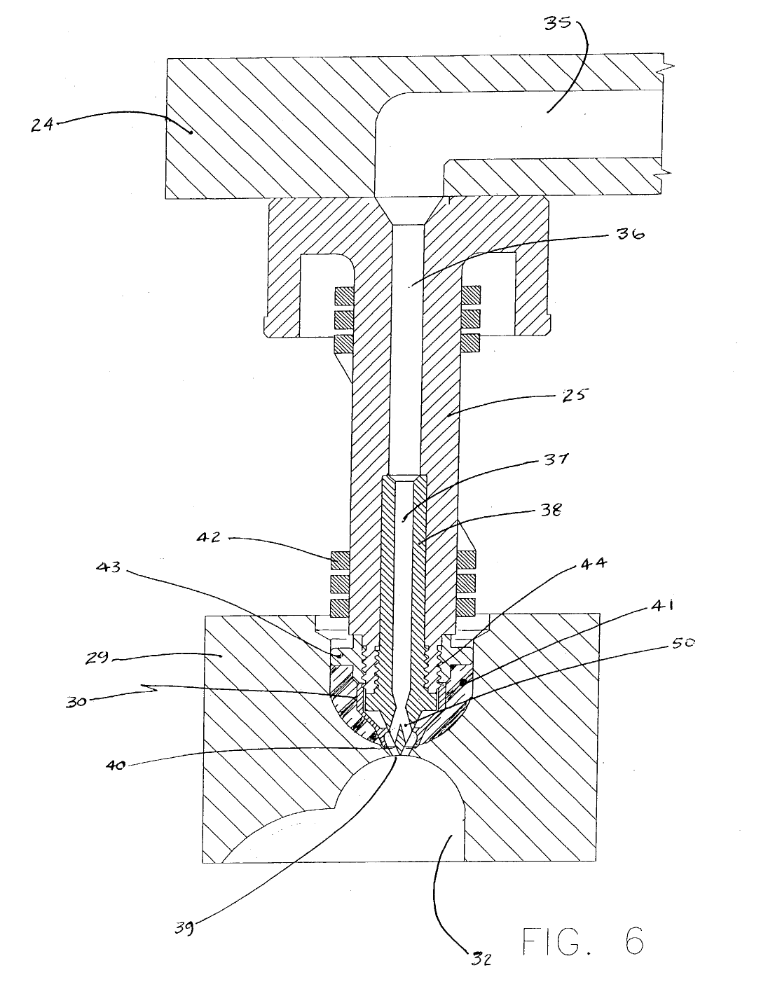

In a second embodiment of the invention, FIG. 7 is a nozzle constructed with the heating element 51 internal to the body 52 of the nozzle and hermetically sealed to prevent corrosion due to the absorption of moisture. In this design, tip 53 has only one orifice 54, rather than two orifices as in design shown in FIG. 3 through FIG. 6, in order to keep the mass of the tip from being reduced further by the hollow of a second orifice. Tip Jacket 55 is assembled to the nozzle body using external thread 56, however a press fit could also be used.

Opening 57 between tip and jacket is shaped in such a way as to deflect the flow of molten plastic coming through orifice 54.

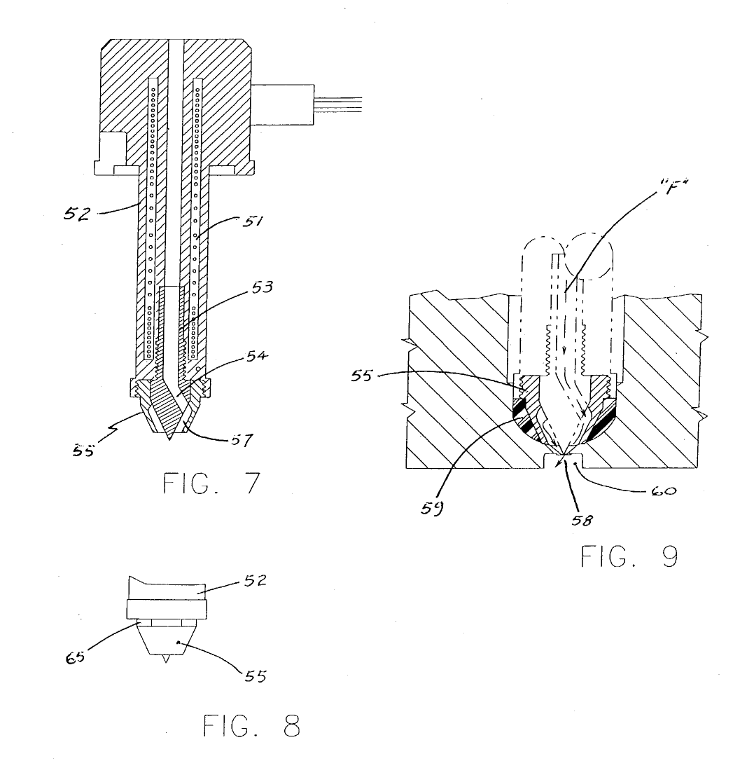

FIG. 8 is the front section of nozzle 52 shown with tip jacket 55 assembled. Flats 65 allow tightening of the jacket to the nozzle by using a socket wrench.

FIG. 9 shows the relationship of the tip jacket with the gate. Plastic flow represented y arrows “F” is directed towards the gate 58 of cavity 60. Insulating pool 59 is filled with plastic from the process as previously described, which is separated from the flowing molten resin by the walls of jacket 55, so that all the plastic filling cavity 60 is fresh melt directly from the press's barrel and not contaminated with any plastic in the pool 59 which may have had a long exposure to elevated temperature or may be of a different color.

In FIG. 10, the tip jacket 30 is viewed by itself and not assembled to a nozzle. It is a thin walled, light weight stainless steel, titanium or ceramic part. It follows the general shape of the tip of the nozzle's torpedo except it is truncated in order to allow the tip to protrude past the jacket's length into the center of the gate itself. Flats 61 are provided for the purpose of permitting secure tightening by means of a wrench.

FIG. 11, is a cross section taken along line “B”-“B” of FIG. 12. Internal thread 63 mates to the thread in the forward portion of the nozzle. Circular fin 47 extends towards the center, ending into a diameter equal to the diameter of the tip at the point of contact with the jacket. Radius 62 forms a fillet at the point of intersection of the fin with the jacket's outer wall and has the double purpose of reinforcing the wall and of directing the melt flow towards the gate.

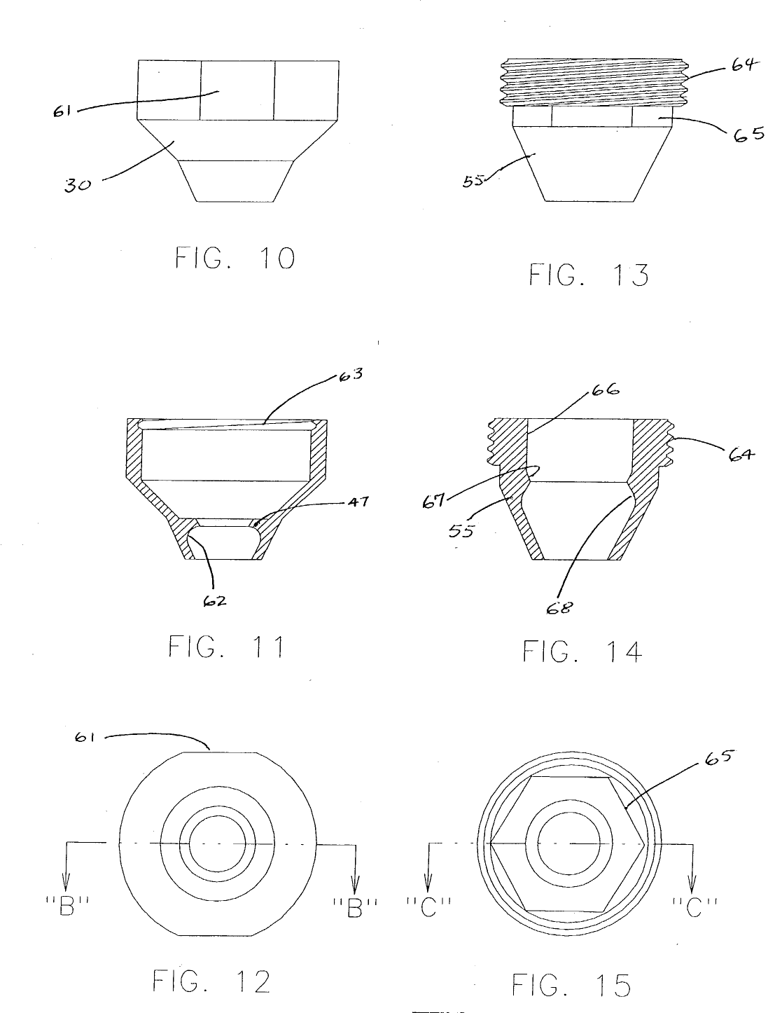

FIG. 13 is a side view of a different design of jacket which has the fastening thread 64 on the outside of jacket 55. Hexagonal flats 65, seen more clearly in FIG. 15, are provided for tightening and removing the jacket to the nozzle by using a wrench.

Referring to FIG. 14, which is a cross-section of tip 55 taken along line “C”-“C” of FIG. 15, diameter 66 is slightly larger than the diameter of the torpedo tip which fits in it, and it ends into a small abutment 67 matching the angle of the tip's cone. Radius 68 lines up with the discharge port of the torpedo and is tangent to the internal wall of the jacket, in such a way as to deflect the flow of molten resin coming out of the tip's orifice and direct it towards the gate and into the part.

The above description represents two preferred embodiments of the invention chosen because they are deemed to be effective in their intended scope, economical to manufacture and durable. It is obvious that one skilled in the art could make modifications and adapt them to various forms of plastic injection molding apparatus. Therefore this invention should be construed broadly and in accordance with its true spirit and scope.

1. (canceled)

2. An apparatus, comprising:
an injection molding tip jacket for use with an injection molding nozzle, injection molding tip jacket including:
i) a cylindrical section; and
ii) a conical section adjoining said cylindrical section, said conical section being tapered in a direction extending away from said cylindrical section, said conical section including a wall a portion of which is thin to minimize heat transfer while serving as a barrier to separate flowing molding material from molding material which has filled an insulating gap between said conical section and a mold.

3. The apparatus of claim 3, further comprising:
a separate internally threaded collar positioned between said tip jacket assembly and a body of said nozzle, said collar being secured by said internal threads to said nozzle.

4. The apparatus of claim 3, wherein said collar has a cylindrical outer section suitable for insertion into said mold, said cylindrical outer section having a flat top portion for securely contacting and sealing a nozzle body surface contacted by said flat top portion.

5. The apparatus of claim 4, wherein said conical portion of said injection molding tip jacket further includes:
a protrusion partially extending towards the inside of said conical portion.

6. The apparatus of claim 5, wherein said protrusion extends into close proximity to a torpedo used to guide the flow of molding material, said protrusion defining a flow area through which said molding material flows towards a cavity of said mold.

7. The apparatus of claim 5, wherein the cylindrical section of said tip jacket further includes internal threads.

8. The apparatus of claim 5, wherein the cylindrical section of said tip jacket further includes external threads.

9. The apparatus of claim 5, wherein at least a portion of said cylindrical section of said tip jacket includes:
means for interfacing with a fastening tool to allow said tip jacket to be secured to said nozzle using said fastening tool.

10. The apparatus of claim 9, wherein said means for interfacing includes parallel flat portions.

11. The apparatus of claim 9, wherein said means for interfacing includes hexagonal flats.

12. The apparatus of claim 5, wherein said nozzle includes both internal and external threads, said internal threads being suitable for securing said torpedo to said nozzle, said external threads being suitable for interfacing with the threads of said collar and said injection molding tip jacket.
